(19) United States
(12) Patent Application Publication
(10) Pub. No.: US 2026/0026667 A1
(43) Pub. Date: Jan. 29, 2026

(54) RANGING APPARATUS AND CLEANING ROBOT

(71) Applicant: Beijing Roborock Technology Co., Ltd., Beijing (CN)

(72) Inventors: Liang DANG, Beijing (CN); Mochen YU, Beijing (CN); Kaijing WANG, Beijing (CN); Xiaoming LIU, Beijing (CN); Zheng WANG, Beijing (CN); Dan LIU, Beijing (CN); Guangchuan WU, Beijing (CN)

(73) Assignee: Beijing Roborock Technology Co., Ltd., Beijing (CN)

(21) Appl. No.: 19/350,388

(22) Filed: Oct. 6, 2025

Related U.S. Application Data
(63) Continuation of application No. PCT/CN2024/090126, filed on Apr. 26, 2024.

(51) Int. Cl. A47L 11/40; G01S 7/481; G01S 17/08

(52) U.S. Cl. CPC A47L 11/4008; G01S 7/4812; G01S 7/4818; G01S 17/08

(57) ABSTRACT

A ranging apparatus includes: a light emitter (101) and at least two photodetectors. The light emitter (101) is configured to emit probe light. The at least two photodetectors include a first photodetector (102) and a second photodetector (103). The first photodetector (102) is configured to receive first signal light reflected by a to-be-detected target (100) under the action of the probe light and output a first echo signal; the second photodetector (103) is configured to receive second signal light reflected by the to-be-detected target (100) under the action of the probe light and output a second echo signal, thereby obtaining a target distance based on the ratio of the first echo signal to the second echo signal.

The present disclosure is a continuation of PCT Application No. PCT/CN2024/090126, filed on Apr. 26, 2024, which claims priority to Chinese Patent Application No. 2023104300682 filed on Apr. 20, 2023, the content of which is incorporated herein by reference in its entirety.

### TECHNICAL FIELD

The present disclosure relates to a ranging apparatus and a cleaning robot.

### BACKGROUND

In robot positioning technologies, reflective ranging sensors, such as laser or infrared sensors, are commonly used to perform a distance measurement between a robot and a to-be-detected target.

### SUMMARY

In a first aspect, one embodiment of the present disclosure provides a ranging apparatus. The ranging apparatus includes: a light emitter and at least two photodetectors, where
the light emitter is configured to emit probe light;

the at least two photodetectors include a first photodetector and a second photodetector, where the first photodetector is configured to receive first signal light reflected by a to-be-detected target under action of the probe light and output a first echo signal, and the second photodetector is configured to receive second signal light reflected by the to-be-detected target under the action of the probe light and output a second echo signal, thereby obtaining a target distance based on a ratio of the first echo signal to the second echo signal.

In a second aspect, one embodiment of the present disclosure provides a cleaning robot. The cleaning robot includes a robot main body and the ranging apparatus according to the above first aspect, where the ranging apparatus is arranged on the robot main body.

The above description is only an overview of the technical solutions according to the present disclosure. In order to more clearly understand the technical means of the present disclosure to enable implementation in accordance with the content of this specification and to make the above and other features and effects of the present disclosure more obvious and easier to understand, the detailed description of the embodiments of the present disclosure is provided below.

### BRIEF DESCRIPTION OF THE DRAWINGS

The drawings herein, which are incorporated into and constitute a part of the specification, illustrate embodiments consistent with the present disclosure and are used in conjunction with the specification to explain the principles of the present disclosure. Apparently, the drawings in the following description are merely some embodiments of the present disclosure, and those of ordinary skill in the art may still derive other drawings from these drawings without creative efforts. In the drawings:

FIG. 1 is a schematic diagram of an exemplary structure of a ranging apparatus according to one embodiment of the present disclosure;

FIG. 2 is a curve illustrating an exemplary relationship between an overlapping area and

a distance according to one embodiment of the present disclosure;

FIG. 3 is a curve illustrating an exemplary relationship between a ratio of overlapping areas and a distance according to one embodiment of the present disclosure;

FIG. 4 is an optical path diagram of target scattered light according to one embodiment of the present disclosure;

FIGS. 5 to 13 are schematic diagrams of nine exemplary structures of a ranging apparatus according to one embodiment of the present disclosure; and

FIG. 14 is a schematic structural diagram of a cleaning robot according to one embodiment of the present disclosure.

### DETAILED DESCRIPTION

Exemplary embodiments of the present disclosure will be described in more detail below with reference to the drawings. It should be noted that, in the drawings, dimensions of elements may be exaggerated for clarity of illustration. While the exemplary embodiments of the present disclosure are shown in the drawings, it should be understood that the present disclosure may be implemented in various forms and should not be limited by the embodiments set forth herein. Rather, these embodiments are provided such that the present disclosure will be more thoroughly understood and the scope of the present disclosure will be fully conveyed to those skilled in the art.

It should be noted that the term “and/or” as used herein is merely a way to describe an association relationship between associated objects, indicating that three possible relationships may exist. For example, “A and/or B” can represent: the existence of A alone, the simultaneous existence of A and B, and the existence of B alone. The terms “plurality of” and “at least two” include the case of two or more. The terms “first”, “second”, “third”, and the like are used only as labels, and are not intended to limit the number and sequence of objects thereof. The terms “front”, “rear”, “upper”, “lower”, “left”, “right”, and the like are used only to indicate the relative positional relationship, and when the absolute position of the described object is changed, the relative positional relationship may also be changed accordingly.

The accuracy of the distance measurement result affects the reliability of robot positioning and path planning. Therefore, there is a need to provide a ranging apparatus capable of performing relatively accurate measurements.

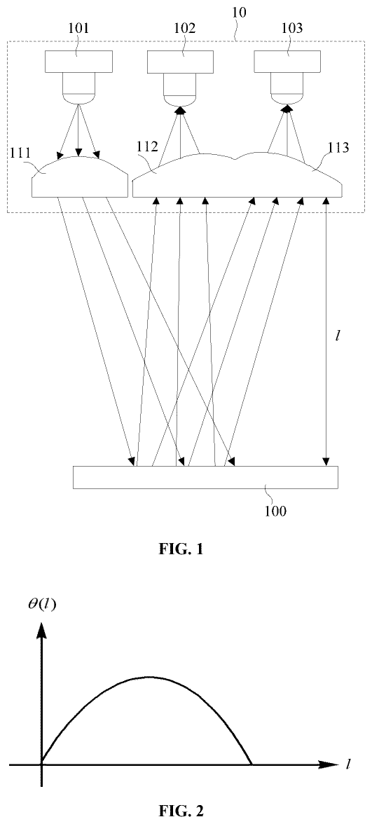

One embodiment of the present disclosure provides a ranging apparatus 10. As shown in FIG. 1, the ranging apparatus 10 includes: a light emitter 101 and at least two photodetectors.

The light emitter 101 is configured to emit probe light. For example, the probe light may be infrared light, or may be a laser, which is not limited in the embodiment.

The at least two photodetectors include a first photodetector 102 and a second photodetector 103. The first photodetector 102 is configured to receive first signal light reflected by a to-be-detected target 100 under the action of the probe light and output a first echo signal, and the second photodetector 103 is configured to receive second signal light reflected by the to-be-detected target 100 under the action of the probe light and output a second echo signal, thereby obtaining a target distance, which corresponds to the distances between the photodetectors and the to-be-detected target 100, based on the ratio of the first echo signal to the second echo signal.

Essentially, a reflective sensor determines the distance based on the intensity (echo count) of the signal light reflected from the reflective surface. The ranging result tends to be affected by the reflective material. When the distances between the photodetectors and the to-be-detected target 100 are the same, the reflectivity of the to-be-detected target 100 made of different materials varies, thereby resulting in differences in energy of the returned signal light, which in turn leads to different ranging results obtained based on the energy of the returned signal light and adversely affects the accuracy of the ranging result.

In the embodiment of the present disclosure, at least one photodetector is added based on the solution including a pair of a light emitter 101 and a photodetector, thereby allowing the same to-be-detected target 100 to be tested simultaneously by two or more photodetectors. Taking the above solution of providing the first photodetector 102 and the second photodetector 103 as an example, the first echo signal and the second echo signal can be obtained through one detection operation, the ratio of the first echo signal to the second echo signal is calculated, and then the target distance is obtained based on the ratio. Since the ratio of the signals is independent of the material of the reflective surface, the influence of different materials on the measurement result can be effectively eliminated, thereby improving the accuracy of the distance measurement result.

It should be noted that the description herein is primarily based on an example where two photodetectors, that is, the first photodetector 102 and the second photodetector 103 described above, are arranged corresponding to one light emitter 101. In other examples, the number of the photodetectors may also be more than two, which is not limited in the embodiment. For example, in addition to the first photodetector 102 and the second photodetector 103, a third photodetector may also be provided. In this way, three sets of echo signals can be obtained, and thus the ratio is calculated in pairs to obtain three sets of distance measurement results, and then the final measurement result is obtained by averaging or other means.

In actual implementation, the viewing regions of the first photodetector 102 and the second photodetector 103 at least partially overlap with the irradiation region of the light emitter 101, thereby ensuring that both the first photodetector 102 and the second photodetector 103 can receive the reflected light of the to-be-detected target 100 under the action of the probe light. It can be understood that the overlapping area between the viewing region and the irradiation region is positively correlated with the intensity of the reflected signal light received by the photodetector; that is, the larger the overlapping area, the stronger the intensity of the received reflected signal light.

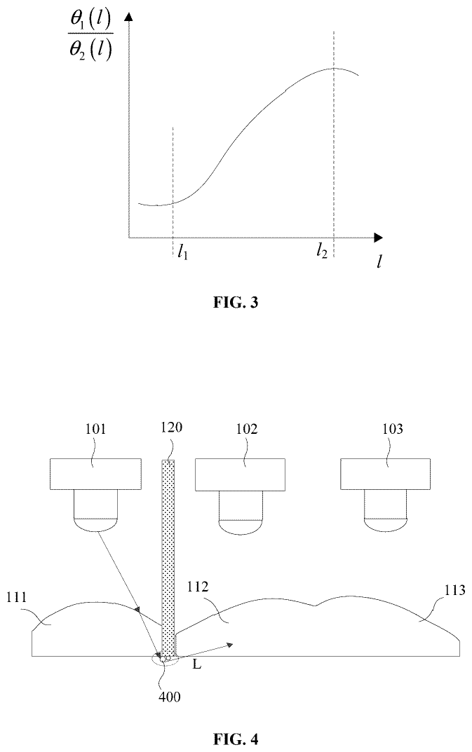

Therefore, the relationship between the above overlapping area θ(l) and the to-be-measured distance l can be configured for each photodetector. For example, as shown in FIG. 2, the above overlapping area θ(l) may first increase and then decrease as the to-be-measured distance l increases. Here, for ease of distinguishing, the overlapping area between the viewing region of the first photodetector 102 and the irradiation region of the light emitter 101 is referred to as a first overlapping area, and the overlapping area between the viewing region of the second photodetector 103 and the irradiation region of the light emitter 101 is referred to as a second overlapping area.

In some examples, the first photodetector 102 and the second photodetector 103 are at equal distances from the to-be-detected target 100. For example, the central axes of the light emitter 101, the first photodetector 102, and the second photodetector 103 are parallel, and in a direction of the central axis, the light-emergent surface of the light emitter 101, the light-incident surface of the first photodetector 102, and the light-incident surface of the second photodetector 103 are flush. In this case, it may be considered that the light emitter 101, the first photodetector 102, and the second photodetector 103 are at equal distances from the same to-be-detected target 100.

In this case, the optical paths of the light emitter 101, the first photodetector 102, and the second photodetector 103 are configured, such that the first overlapping area is different from the second overlapping area when the to-be-measured distances are equal, and within a preset distance range, the ratio of the first overlapping area to the second overlapping area is positively or negatively correlated with the distance. It should be noted that the preset distance range is designed based on the needs of actual application scenarios.

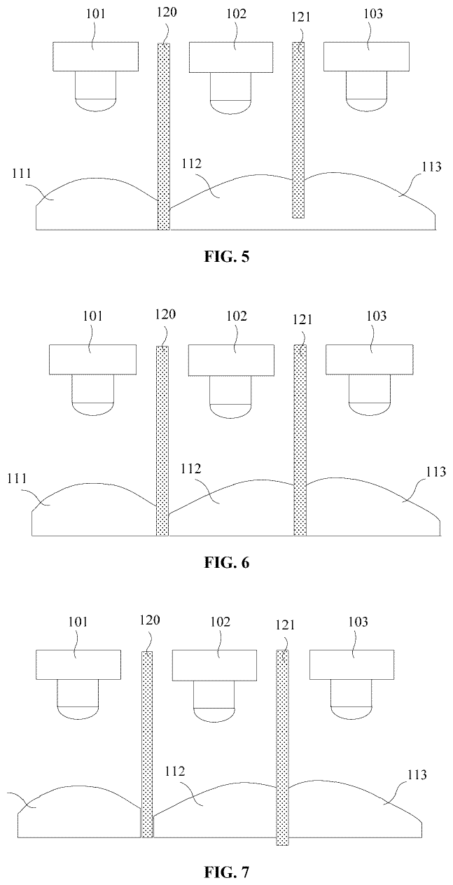

For example, the to-be-measured distance is represented as l, the first overlapping area is represented as θ₁(l), and the second overlapping area is represented as θ₂(l). As shown in FIG. 3, taking the example where, within the preset distance range (l₁, l₂),

$$\frac{{θ}_{1} ( l )}{{θ}_{2} ( l )}$$

is positively correlated with the distance l, the ratio of the photocurrent corresponding to the first echo signal to the photocurrent corresponding to the second echo signal

$$\frac{{I}_{1} ( l )}{{I}_{2} ( l )}$$

is proportional to

$$\frac{{θ}_{1} ( l )}{{θ}_{2} ( l )} .$$

Therefore, the ratio of the voltage magnitude of the first echo signal to the voltage magnitude of the second echo signal can be positively correlated with the distance l, thereby determining the target distance based on the ratio of the voltage magnitude of the first echo signal to the voltage magnitude of the second echo signal.

For example, a large amount of sample data may be first collected for curve fitting to determine the correspondence relationship between the above ratio of the first echo signal to the second echo signal and the distance, and then the ratio is substituted into the above correspondence relationship to determine the target distance after the ratio is actually measured. Alternatively, a correspondence table between the above ratio and the distance may be constructed in advance, and the actually measured ratio is matched with the above correspondence table to obtain the target distance.

It should be noted that the ratio of the first echo signal to the second echo signal may be the ratio of the first echo signal to the second echo signal, or the ratio of the second echo signal to the first echo signal, which is set based on actual needs and is not limited in the embodiment.

In order to facilitate the adjustment of the optical paths of the light emitter 101, the first photodetector 102, and the second photodetector 103, the ranging apparatus 10 further includes: a first optical lens 112 arranged corresponding to the first photodetector 102, a second optical lens 113 arranged corresponding to the second photodetector 103, and a third optical lens 111 arranged corresponding to the light emitter 101. The probe light emitted by the light emitter 101 is directed onto the surface of the to-be-detected target 100 after optical path adjustment by the third optical lens 111. The first signal light reflected by the to-be-detected target 100 under the action of the probe light is received by the second photodetector 103 after optical path adjustment by the first optical lens 112. The second signal light reflected by the to-be-detected target 100 under the action of the probe light is received by the second photodetector 103 after optical path adjustment by the second optical lens 113.

In actual implementation, in order to prevent a portion of the large-angle probe light emitted by the light emitter 101 from being received by the photodetector and affecting the distance measurement result, a baffle may be arranged between the light emitter 101 and the photodetector arranged adjacent to the light emitter, thereby blocking the portion of the large-angle probe light.

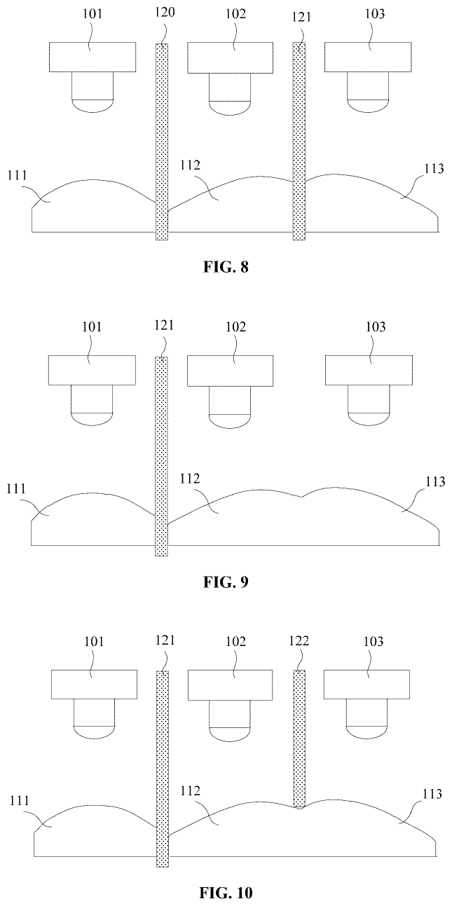

For example, as shown in FIG. 4, when the light emitter 101, the first photodetector 102, and the second photodetector 103 are arranged in sequence, the first photodetector 102 is arranged adjacent to the light emitter 101, and the second photodetector 103 is arranged on a side of the first photodetector 102 distal to the light emitter 101, such that a baffle 120 can be arranged between the light emitter 101 and the first photodetector 102, thereby preventing the large-angle probe light from entering the optical lens of the first photodetector 102 and from being received by the first photodetector 102. The baffle described herein is a baffle having a light-blocking function. For example, the baffle may be made of a black light-blocking material.

In some examples, the mirror surface on the light-incident side of the first optical lens 112, the mirror surface on the light-incident side of the second optical lens 113, and the mirror surface on the light-emergent side of the third optical lens 111 are flush, thereby minimizing dust accumulation on the outer mirror surfaces. The end of the above baffle 120 may be embedded between the first optical lens 112 and the third optical lens 111, and may be flush with the light-incident side of the first optical lens 112 and the light-emergent side of the third optical lens 111. In this way, the mirror surfaces are less prone to dust accumulation.

Further, the inventors have found in the research process that, as the use time increases, dust will inevitably accumulate on the mirror surface on the light-emergent side of the third optical lens 111, and when the probe light emitted by the light emitter 101 is directed onto the dust, a Tyndall effect will occur; that is, a scattering phenomenon occurs around the dust to change the propagation direction of the light. Especially when there is dust near the mirror surface region of the photodetector, the formed scattered light tends to be received by the first photodetector 102 and the second photodetector 103, thereby causing errors and affecting the final measurement result. For example, a distance measurement result is generated in the absence of the to-be-detected target 100, thereby resulting in a misjudgment.

As shown in FIG. 4, when there is dust 400 at the position indicated by the elliptical dashed box, the probe light emitted by the light emitter 101 is scattered when it is directed onto the dust 400, and the formed target scattered light L enters the first optical lens 112 and further enters the second optical lens 113, and is then received by the second photodetector 103, thereby resulting in an incorrect measurement result.

In view of this, the ranging apparatus 10 according to one embodiment of the present disclosure further includes: a light baffle 121. The light baffle 121 is configured to prevent the target scattered light from entering the first photodetector 102 and/or the second photodetector 103, thereby effectively mitigating the interference problem caused by the mirror surface dust resulting from the above Tyndall effect, and helping improve the accuracy of the distance measurement result. The target scattered light is scattered light formed when the probe light is directed onto dust on the mirror surface on the light-emergent side of the third optical lens 111. It should be noted that the light baffle 121 described herein has a light-blocking function. For example, the light baffle may be made of the same black light-blocking material as the baffle 120.

In specific implementation, the arrangement of the light baffle 121 is related to the arrangement method of the light emitter 101, the first photodetector 102, and the second photodetector 103. It is assumed that T represents the light emitter 101, R1 represents the first photodetector 102, and R2 represents the second photodetector 103. Here, the light emitter 101, the first photodetector 102, and the second photodetector 103 may be arranged in an order of TR1R2, or may be arranged in an order of R1TR2.

Exemplary arrangement methods of the light baffle 121 when the first photodetector 102 is arranged in the order of TR1R2, that is, arranged between the light emitter 101 and the second photodetector 103, will be first described as follows.

According to a first arrangement method, the above light baffle 121 is provided between the first photodetector 102 and the second photodetector 103, thereby preventing the above target scattered light from entering the second photodetector 103. In addition, the baffle 120 is provided between the first photodetector 102 and the light emitter 101, thereby blocking the large-angle probe light emitted by the light emitter 101 from being received by the first photodetector 102 and the second photodetector 103 and from interfering with the distance measurement result. For example, the end of the baffle 120 may be flush with the mirror surface on the light-emergent side of the third optical lens 111, thereby reducing the mirror surface dust.

In this case, the ratio of the voltage magnitude of the second echo signal to the voltage magnitude of the first echo signal is used as the ratio of the first echo signal to the second echo signal. In this way, the light baffle 121 can block the scattered light formed due to the Tyndall effect from entering the second photodetector 103 through the region where the first photodetector 102 is located. Although the first photodetector 102 may receive the target scattered light, the second echo signal as a molecule is zero, and the ratio of the voltage magnitude of the second echo signal to the voltage magnitude of the first echo signal is zero, thereby effectively avoiding the incorrect measurement result caused by receiving the target scattered light, mitigating the interference problem caused by the mirror surface dust resulting from the Tyndall effect, and helping improve the accuracy of the distance measurement result.

In some examples, considering that the first photodetector 102 is arranged adjacent to the second photodetector 103, in order to save the mold costs, the first optical lens 112 and the second optical lens 113 may be integrally arranged.

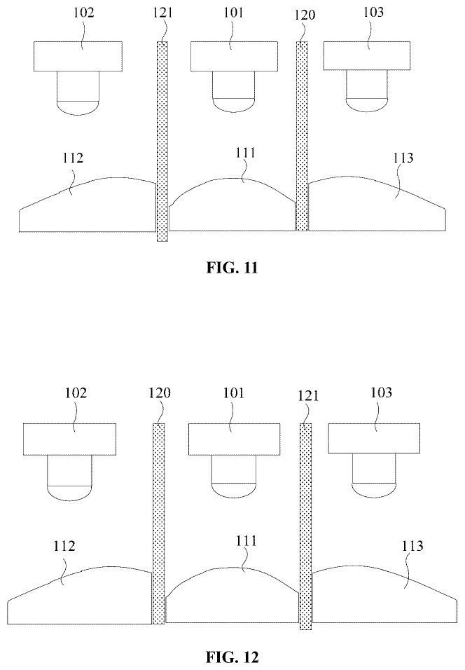

As shown in FIG. 5, the mirror surfaces on the light-incident sides of the first optical lens 112 and the second optical lens 113 are integrally arranged, and the light baffle 121 is embedded into an opening between the first optical lens 112 and the second optical lens 113 from a light-emergent side. That is, the mirror surfaces on the light-incident sides of the first optical lens 112 and the second optical lens 113 are not penetrated by the light baffle 121. In this way, the first optical lens 112 and the second optical lens 113 can be integrally processed, thereby eliminating the need to design additional molds and saving the mold costs.

It should be noted that the distances between the end of the light baffle 121 and the mirror surfaces on the light-incident sides of the first optical lens 112 and the second optical lens 113 are set based on the angle of the scattered light to be blocked and the process requirements. The end of the light baffle 121 refers to an end close to the light-incident sides of the first optical lens 112 and the second optical lens 113.

In some examples, the first optical lens 112 and the second optical lens 113 may also be arranged independently of each other. As shown in FIG. 6, the end of the light baffle 121 may be embedded between the first optical lens 112 and the second optical lens 113, and the end of the light baffle 121, the mirror surface on the light-incident side of the first optical lens 112, and the mirror surface on the light-incident side of the second optical lens 113 may be flush. In this way, the mirror surfaces are less prone to dust accumulation. Alternatively, as shown in FIG. 7, the end of the light baffle 121 may protrude from the mirror surface on the light-incident side of the first optical lens 112, thereby better blocking the above target scattered light. For example, the end of the light baffle 121 may protrude by 0.3 mm to 1 mm, such as 0.3 mm, 0.4 mm, or 0.5 mm, beyond the mirror surface on the light-incident side of the first optical lens 112, which may be set based on actual needs.

As shown in FIG. 8, in some examples, the end of the above baffle 120 may also protrude from the mirror surface on the light-emergent side of the third optical lens 111, thereby preventing the above target scattered light from entering the region where the first photodetector 102 is located and from being received by the first photodetector 102, further mitigating the interference problem caused by the mirror surface dust resulting from the Tyndall effect, and reducing the limitation on the signal processing process. For example, the end of the baffle 120 may protrude by 0.3 mm to 1 mm, such as 0.3 mm, 0.4 mm, or 0.5 mm, beyond the mirror surface on the light-emergent side of the third optical lens 111, which may be set based on actual needs.

According to a second arrangement method, as shown in FIG. 9, the light baffle 121 is provided between the light emitter 101 and the first photodetector 102, and the end of the light baffle 121 is embedded between the first optical lens 112 and the third optical lens 111 and protrudes from the mirror surface on the light-emergent side of the third optical lens 111, thereby preventing the target scattered light and the large-angle probe light from entering the first photodetector 102 and the second photodetector 103. For example, the end of the light baffle 121 may protrude by 0.3 mm to 1 mm, such as 0.3 mm, 0.4 mm, or 0.5 mm, beyond the mirror surface on the light-emergent side of the third optical lens 111, which may be set based on actual needs.

In this case, no blocking is required between the first photodetector 102 and the second photodetector 103, as shown in FIG. 9. Alternatively, as shown in FIG. 10, a signal light baffle 122 may also be arranged between the first photodetector 102 and the second photodetector 103. The end of the signal light baffle 122 is located on the light-emergent sides of the first optical lens 112 and the second optical lens 113, and does not need to be embedded between the first optical lens 112 and the second optical lens 113, such that the large-angle signal light emitted by the first optical lens 112 can be blocked from entering the second photodetector 103, and the large-angle signal light emitted by the second optical lens 113 can be blocked from entering the first photodetector 102, thereby reducing the interference between the two photodetectors, improving the accuracy of the distance measurement result without affecting the arrangement of the first optical lens 112 and the second optical lens 113, and reducing the processing costs.

When the light emitter 101, the first photodetector 102, and the second photodetector 103 are arranged in the order of R1TR2, the light emitter 101 is located between the first photodetector 102 and the second photodetector 103, and the light emitter 101 is adjacent to both the first photodetector 102 and the second photodetector 103. In this case, the exemplary arrangement methods of the light baffle 121 may be as follows:

According to a first arrangement method, as shown in FIG. 11, the light baffle 121 is provided between the light emitter 101 and the first photodetector 102, and the end of the light baffle 121 is embedded between the first optical lens 112 and the third optical lens 111 and arranged to protrude from the mirror surface on the light-emergent side of the third optical lens 111. In one aspect, the large-angle probe light can be blocked from entering the first photodetector 102; in another aspect, the above target scattered light can be prevented from entering the region where the first photodetector 102 is located and from being received by the first photodetector 102. In addition, the baffle 120 is provided between the light emitter 101 and the second photodetector 103, and the end of the baffle 120 is embedded between the second optical lens 113 and the third optical lens 111 and is flush with the mirror surface on the light-emergent side of the third optical lens 111, thereby blocking the large-angle probe light from entering the second photodetector 103.

Correspondingly, the ratio of the voltage magnitude of the first echo signal to the voltage magnitude of the second echo signal is used as the ratio of the first echo signal to the second echo signal. In this way, when there is the above scattered light formed due to the Tyndall effect, the first echo signal as a molecule is zero, and the ratio of the voltage magnitude of the first echo signal to the voltage magnitude of the second echo signal is zero, thereby effectively avoiding the incorrect measurement result caused by receiving the dust-induced scattered light, and mitigating the interference problem caused by the mirror surface dust resulting from the Tyndall effect.

According to a second arrangement method, as shown in FIG. 12, the light baffle 121 is provided between the light emitter 101 and the second photodetector 103, and the end of the light baffle 121 is embedded between the second optical lens 113 and the third optical lens 111 and is arranged to protrude from the mirror surface on the light-emergent side of the third optical lens 111. In one aspect, the large-angle probe light can be blocked from entering the second photodetector 103; in another aspect, the above target scattered light can be prevented from entering the region where the second photodetector 103 is located and from being received by the second photodetector 103. In addition, the baffle 120 is provided between the light emitter 101 and the first photodetector 102, and the baffle 120 is embedded between the first optical lens 112 and the third optical lens 111 and is flush with the mirror surface on the light-emergent side of the third optical lens 111, thereby blocking the large-angle probe light from entering the first photodetector 102. Correspondingly, the ratio of the voltage magnitude of the second echo signal to the voltage magnitude of the first echo signal is used as the ratio of the first echo signal to the second echo signal.

According to a third arrangement method, as shown in FIG. 13, light baffles 121 are provided between the light emitter 101 and the first photodetector 102, and between the light emitter 101 and the second photodetector 103. The arrangement method of the light baffle 121 may refer to the first method and the second method described above, which is not repeated herein. In this way, the target scattered light on both sides can be prevented from entering the first photodetector 102 and the second photodetector 103.

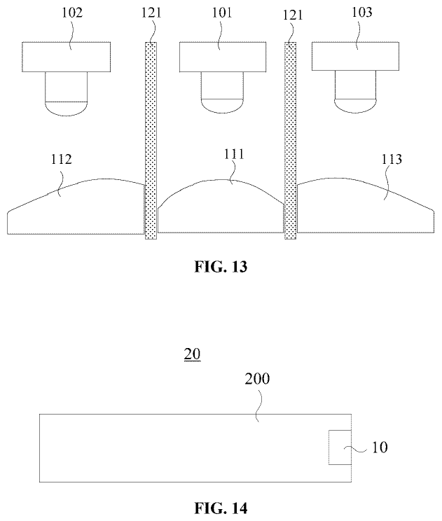

In addition, one embodiment of the present disclosure further provides a cleaning robot. As shown in FIG. 14, the cleaning robot 20 includes a robot main body 200 and the ranging apparatus 10 according to any one of the above embodiments, and the ranging apparatus 10 is arranged on the robot main body 200. The specific structure of the robot main body 200 and the arrangement position of the ranging apparatus 10 on the robot main body 200 are determined based on the needs of actual application scenarios. For example, the cleaning robot 20 may be a sweeping robot, a mopping robot, a sweeping and mopping integrated robot, a window cleaning robot, or the like, which is not limited in the embodiment.

Taking the sweeping robot as an example, in order to achieve obstacle detection of the sweeping robot along a wall, the above ranging apparatus 10 may be arranged on a side surface, such as a right side, of the robot main body 200, thereby accurately detecting the distance between the sweeping robot and the wall and improving the reliability of travel path planning along the wall.

It should be noted that the embodiments in the present disclosure are each described in a progressive manner, and each embodiment focuses on differences from other embodiments, and reference should be made to each other for the same or similar parts.

Those of ordinary skill in the art should understand that the discussion of any of the above embodiments is only exemplary, and is not intended to imply that the scope of the present disclosure is limited to these examples. Under the idea of the present disclosure, the technical features in the above embodiments or different embodiments may also be combined, the steps may be implemented in any order, and there are many other variations in different aspects of one or more embodiments of the present disclosure as described above, which are not provided in detail for the sake of clarity.

Although the exemplary embodiments of the present disclosure have been described, those skilled in the art may make additional changes and modifications to these embodiments once they learn of the basic inventive concepts. Therefore, the attached claims are intended to be interpreted as including the exemplary embodiments and all changes and modifications falling within the scope of the present disclosure.

In a first aspect, one embodiment of the present disclosure provides a ranging apparatus. The ranging apparatus includes: a light emitter and at least two photodetectors, where
the light emitter is configured to emit probe light;
the at least two photodetectors include a first photodetector and a second photodetector, where the first photodetector is configured to receive first signal light reflected by a to-be-detected target under action of the probe light and output a first echo signal, and the second photodetector is configured to receive second signal light reflected by the to-be-detected target under the action of the probe light and output a second echo signal, thereby obtaining a target distance based on a ratio of the first echo signal to the second echo signal.

In an optional example, the first photodetector and the second photodetector are at equal distances from the to-be-detected target, and

within a preset distance range, a ratio of a first overlapping area to a second overlapping area is positively or negatively correlated with the distance, where the first overlapping area is an overlapping area between a viewing region of the first photodetector and an irradiation region of the light emitter, and the second overlapping area is an overlapping area between a viewing region of the second photodetector and the irradiation region of the light emitter.

In an optional example, the above ranging apparatus further includes: a first optical lens, a second optical lens, a third optical lens, and a light baffle, the probe light emitted by the light emitter is emitted through the third optical lens, the first signal light enters the first photodetector through the first optical lens, and the second signal light enters the second photodetector through the second optical lens;
the light baffle is configured to prevent target scattered light from entering the first photodetector and/or the second photodetector, where the target scattered light is scattered light formed when the probe light is directed onto dust on a mirror surface on a light-emergent side of the third optical lens.

In an optional example, the first photodetector is arranged between the light emitter and the second photodetector, and
the light baffle is provided between the first photodetector and the second photodetector, thereby preventing the target scattered light from entering the second photodetector.

In an optional example, mirror surfaces on light-incident sides of the first optical lens and the second optical lens are integrally arranged, and the light baffle is embedded into an opening between the first optical lens and the second optical lens from a light-emergent side.

In an optional example, the first optical lens and the second optical lens are arranged independently of each other, and an end of the light baffle is embedded between the first optical lens and the second optical lens;
the end of the light baffle, the mirror surface on the light-incident side of the first optical lens, and the mirror surface on the light-incident side of the second optical lens are flush, or the end of the light baffle protrudes from the mirror surface on the light-incident side of the first optical lens.

In an optional example, the above ranging apparatus further includes a baffle, where the baffle is arranged between the light emitter and the first photodetector;
an end of the baffle is embedded between the first optical lens and the third optical lens, and the end of the baffle is flush with the mirror surface on the light-emergent side of the third optical lens, or the end of the baffle protrudes from the mirror surface on the light-emergent side of the third optical lens.

In an optional example, the end of the baffle protrudes by 0.3 mm to 1 mm beyond the mirror surface on the light-emergent side of the third optical lens.

In an optional example, the first photodetector is arranged between the light emitter and the second photodetector,
the light baffle is provided between the light emitter and the first photodetector, and an end of the light baffle is embedded between the first optical lens and the third optical lens and protrudes from the mirror surface on the light-emergent side of the third optical lens, thereby preventing the target scattered light and large-angle probe light from entering the first photodetector and the second photodetector.

In an optional example, the light emitter is arranged between the first photodetector and the second photodetector,
the light baffle is provided between the light emitter and the first photodetector, and/or between the light emitter and the second photodetector, and the light baffle is arranged to protrude from the mirror surface on the light-emergent side of the third optical lens.

In a second aspect, one embodiment of the present disclosure provides a cleaning robot. The cleaning robot includes a robot main body and the ranging apparatus according to the above first aspect, where the ranging apparatus is arranged on the robot main body.

1. A ranging apparatus, comprising: a light emitter and at least two photodetectors, wherein
the light emitter is configured to emit probe light;
the at least two photodetectors comprise a first photodetector and a second photodetector, wherein the first photodetector is configured to receive first signal light reflected by a to-be-detected target under action of the probe light and output a first echo signal, and the second photodetector is configured to receive second signal light reflected by the to-be-detected target under the action of the probe light and output a second echo signal, thereby obtaining a target distance based on a ratio of the first echo signal to the second echo signal.

2. The ranging apparatus according to claim 1, wherein the first photodetector and the second photodetector are at equal distances from the to-be-detected target, and
within a preset distance range, a ratio of a first overlapping area to a second overlapping area is positively or negatively correlated with the distance, wherein the first overlapping area is an overlapping area between a viewing region of the first photodetector and an irradiation region of the light emitter, and the second overlapping area is an overlapping area between a viewing region of the second photodetector and the irradiation region of the light emitter.

3. The ranging apparatus according to claim 1, further comprising: a first optical lens, a second optical lens, a third optical lens, and a light baffle, the probe light emitted by the light emitter is emitted through the third optical lens, the first signal light enters the first photodetector through the first optical lens, and the second signal light enters the second photodetector through the second optical lens;
the light baffle is configured to prevent target scattered light from entering at least one of the first photodetector or the second photodetector, wherein the target scattered light is scattered light formed when the probe light is directed onto dust on a mirror surface on a light-emergent side of the third optical lens.

4. The ranging apparatus according to claim 3, wherein the first photodetector is arranged between the light emitter and the second photodetector, and
the light baffle is provided between the first photodetector and the second photodetector, thereby preventing the target scattered light from entering the second photodetector.

5. The ranging apparatus according to claim 4, wherein mirror surfaces on light-incident sides of the first optical lens and the second optical lens are integrally arranged, and the light baffle is embedded into an opening between the first optical lens and the second optical lens from a light-emergent side.

6. The ranging apparatus according to claim 4, wherein the first optical lens and the second optical lens are arranged independently of each other, and an end of the light baffle is embedded between the first optical lens and the second optical lens;
the end of the light baffle, the mirror surface on the light-incident side of the first optical lens, and the mirror surface on the light-incident side of the second optical lens are flush, or the end of the light baffle protrudes from the mirror surface on the light-incident side of the first optical lens.

7. The ranging apparatus according to claim 4, further comprising a baffle, wherein the baffle is arranged between the light emitter and the first photodetector; an end of the baffle is embedded between the first optical lens and the third optical lens;
the end of the baffle is flush with the mirror surface on the light-emergent side of the third optical lens, or the end of the baffle protrudes from the mirror surface on the light-emergent side of the third optical lens.

8. The ranging apparatus according to claim 7, wherein the end of the baffle protrudes by 0.3 mm to 1 mm beyond the mirror surface on the light-emergent side of the third optical lens.

9. The ranging apparatus according to claim 3, wherein the first photodetector is arranged between the light emitter and the second photodetector;
the light baffle is provided between the light emitter and the first photodetector, and an end of the light baffle is embedded between the first optical lens and the third optical lens and protrudes from the mirror surface on the light-emergent side of the third optical lens, thereby preventing the target scattered light and large-angle probe light from entering the first photodetector and the second photodetector.

10. The ranging apparatus according to claim 3, wherein the light emitter is arranged between the first photodetector and the second photodetector,
the light baffle is provided between the light emitter and the first photodetector, between the light emitter and the second photodetector, or between the light emitter and the first photodetector and between the light emitter and the second photodetector, and the light baffle is arranged to protrude from the mirror surface on the light-emergent side of the third optical lens.

11. A cleaning robot, comprising a robot main body and a ranging apparatus, wherein the ranging apparatus comprises: a light emitter and at least two photodetectors, wherein
the light emitter is configured to emit probe light;
the at least two photodetectors comprise a first photodetector and a second photodetector, wherein the first photodetector is configured to receive first signal light reflected by a to-be-detected target under action of the probe light and output a first echo signal, and the second photodetector is configured to receive second signal light reflected by the to-be-detected target under the action of the probe light and output a second echo signal, thereby obtaining a target distance based on a ratio of the first echo signal to the second echo signal,
wherein the ranging apparatus is arranged on the robot main body (200).

12. The cleaning robot according to claim 11, wherein the first photodetector and the second photodetector are at equal distances from the to-be-detected target, and
within a preset distance range, a ratio of a first overlapping area to a second overlapping area is positively or negatively correlated with the distance, wherein the first overlapping area is an overlapping area between a viewing region of the first photodetector and an irradiation region of the light emitter, and the second overlapping area is an overlapping area between a viewing region of the second photodetector and the irradiation region of the light emitter.

13. The cleaning robot according to claim 11, further comprising: a first optical lens, a second optical lens, a third optical lens, and a light baffle, the probe light emitted by the light emitter is emitted through the third optical lens, the first signal light enters the first photodetector through the first optical lens, and the second signal light enters the second photodetector through the second optical lens;
the light baffle is configured to prevent target scattered light from entering at least one of the first photodetector or the second photodetector, wherein the target scattered light is scattered light formed when the probe light is directed onto dust on a mirror surface on a light-emergent side of the third optical lens.

14. The cleaning robot according to claim 13, wherein the first photodetector is arranged between the light emitter and the second photodetector, and
the light baffle is provided between the first photodetector and the second photodetector, thereby preventing the target scattered light from entering the second photodetector.

15. The cleaning robot according to claim 14, wherein mirror surfaces on light-incident sides of the first optical lens and the second optical lens are integrally arranged, and the light baffle is embedded into an opening between the first optical lens and the second optical lens from a light-emergent side.

16. The cleaning robot according to claim 14, wherein the first optical lens and the second optical lens are arranged independently of each other, and an end of the light baffle is embedded between the first optical lens and the second optical lens;
the end of the light baffle, the mirror surface on the light-incident side of the first optical lens, and the mirror surface on the light-incident side of the second optical lens are flush, or the end of the light baffle protrudes from the mirror surface on the light-incident side of the first optical lens.

17. The cleaning robot according to claim 14, further comprising a baffle, wherein the baffle is arranged between the light emitter and the first photodetector; an end of the baffle is embedded between the first optical lens and the third optical lens;
the end of the baffle is flush with the mirror surface on the light-emergent side of the third optical lens, or the end of the baffle protrudes from the mirror surface on the light-emergent side of the third optical lens.

18. The cleaning robot according to claim 17, wherein the end of the baffle protrudes by 0.3 mm to 1 mm beyond the mirror surface on the light-emergent side of the third optical lens.

19. The cleaning robot according to claim 13, wherein the first photodetector is arranged between the light emitter and the second photodetector;
the light baffle is provided between the light emitter and the first photodetector, and an end of the light baffle is embedded between the first optical lens and the third optical lens and protrudes from the mirror surface on the light-emergent side of the third optical lens, thereby preventing the target scattered light and large-angle probe light from entering the first photodetector and the second photodetector.

20. The cleaning robot according to claim 13, wherein the light emitter is arranged between the first photodetector and the second photodetector,
the light baffle is provided between the light emitter and the first photodetector, between the light emitter and the second photodetector, or between the light emitter and the first photodetector and between the light emitter and the second photodetector, and the light baffle is arranged to protrude from the mirror surface on the light-emergent side of the third optical lens.
